(19) United States
(12) Patent Application Publication
(10) Pub. No.: US 2024/0258956 A1
(43) Pub. Date: Aug. 1, 2024

(54) PORTABLE, FLEXIBLE SOLAR PANELS AND RELATED METHODS AND ASSEMBLIES

(71) Applicant: Dark Energy, LLC, Murray, UT (US)

(72) Inventors: Garrett Aida, Murray, UT (US); Nial Spencer, Murray, UT (US)

(21) Appl. No.: 18/429,363

(22) Filed: Jan. 31, 2024

Related U.S. Application Data
(60) Provisional application No. 63/482,787, filed on Feb. 1, 2023.

(51) Int. Cl. H02S 10/40; H02S 20/30; H02S 30/20; H02S 40/34

(52) U.S. Cl. CPC H02S 10/40; H02S 20/30; H02S 30/20; H02S 40/34

(57) ABSTRACT

A portable solar panel assembly may include a flexible solar panel having an array of solar cells. A support structure may be configured to removably attach to the flexible solar panel when the portable solar panel assembly is in a deployed state. A kickstand may be configured to removably attach to the support structure and configured to support the flexible solar panel at an angle relative to horizontal when the portable solar panel assembly is in a deployed state. A bag may be configured to removably attach to the flexible solar panel and configured to hold an electronic device connected to the flexible solar panel.

### CROSS-REFERENCE TO RELATED APPLICATION

This application claims the benefit under 35 U.S.C. § 119(e) of U.S. Provisional patent application Ser. No. 63/482,787, filed Feb. 1, 2023, the disclosure of which is hereby incorporated herein in its entirety by this reference.

### TECHNICAL FIELD

The present disclosure relates generally to power generation devices and related components and methods. More particularly, the present disclosure relates to solar panels, methods of making solar panels, and assemblies including solar panels.

### BACKGROUND

Solar panels have generally been comprised of monocrystalline or single crystal silicon solar cells. These monocrystalline silicon solar cells are typically cut from a single crystal of silicon made from one large man-made ingot. These large crystals are somewhat fragile and difficult to handle, making them prone to breakage, resulting in higher production costs and less versatility. Solar panels utilized for portable, outdoor, remote applications may experience failure or reduced performance due to elemental exposure and mechanical stresses. Harsh elements and rough working conditions may cause solar panels electrical components to fail rendering the system inefficient or unusable. Physical impacts such as dropping, bending or other external forces can also cause components to break. Portable solar panel systems may also be relatively heavy, prone to failure caused by elemental and physical impact, and may not be compatible with a more universal equipment system.

### BRIEF DESCRIPTION OF THE DRAWINGS

FIG. 1 is a back side view of a portable solar panel assembly in accordance with embodiments of this disclosure;

FIG. 2 is a perspective view of a portable solar panel including the assembly of FIG. 1;

FIG. 3 is a front side view of the portable solar panel of FIG. 2;

FIG. 4 is a back side view of the portable solar panel of FIG. 2;

FIG. 5 is a top view of the portable solar panel of FIG. 2;

FIG. 6 is a bottom view of the portable solar panel of FIG. 2;

FIG. 7 is a perspective back view of another embodiment of a portable solar panel including the assembly of FIG. 1;

FIG. 8 is a perspective back view of the portable solar panel of FIG. 7 depicting a kickstand in accordance with the assembly of FIG. 1 in a deployed state;

FIG. 9 is a top view of a bag in accordance with the assembly of FIG. 1;

FIG. 10 is a side view of the portable solar panel assembly of FIG. 1 in a deployed state;

FIG. 11 is a side elevational view of another embodiment of a portable solar panel assembly in a deployed state;

FIG. 12 is a side elevational view of the portable solar panel assembly of FIG. 1;

FIG. 13 is a back side view of another embodiment of a portable solar panel;

FIG. 14 is a perspective side view of another embodiment of a portable solar panel in a deployed state;

FIG. 15 is a perspective side view of the portable solar panel of FIG. 14, depicting flexibility of the portable solar panel;

FIG. 16 is a perspective side view of an arm band in accordance with embodiments of this disclosure;

FIG. 17 is a perspective side view of a backpack in accordance with embodiments of this disclosure;

FIG. 18 is a front view of a jacket in accordance with embodiments of this disclosure;

FIG. 19 is a front side view of a portable solar panel assembly in accordance with embodiments of this disclosure;

FIG. 20 is a bottom view of the portable solar panel of FIG. 19;

FIG. 21 is perspective view of a compliant mechanism in accordance with embodiments of this disclosure;

FIG. 22 is a perspective view of the compliant mechanism of FIG. 21;

FIG. 23 is a perspective back view of another embodiment of the portable solar panel;

FIG. 24 is a perspective back view of another embodiment of the portable solar panel;

FIG. 25 is a perspective view of another embodiment of the portable solar panel;

FIG. 26 is a perspective view of another embodiment of the portable solar panel; and

FIG. 27 is a perspective view of another embodiment of the portable solar panel.

### DETAILED DESCRIPTION

In the brief summary, the detailed description, the claims, and the accompanying drawings, reference is made to particular features (including method acts) of the present disclosure. It is to be understood that the disclosure includes all possible combinations of such features. For example, where a particular feature is disclosed in the context of a particular embodiment, or a particular claim, that feature can also be used, to the extent possible, in combination with and/or in the context of other aspects and embodiments described herein.

The use of the term “for example” means that the related description is explanatory, and though the scope of the disclosure is intended to encompass the examples and legal equivalents, the use or omission of such terms is not intended to limit the scope of an embodiment or this disclosure to the specified components, acts, features, functions, or the like.

Drawings presented herein are for illustrative purposes and are not necessarily meant to be actual views of any particular material, component, structure, or device. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale. Additionally, elements common between figures may retain the same numerical designation.

As used herein, the term “configured to” in reference to a structure or device intended to perform some function refers to size, shape, material composition, material distribution, orientation, and/or arrangement, etc., of the referenced structure or device.

As used herein, the terms “comprising” and “including,” and grammatical equivalents thereof are inclusive or open-ended terms that do not exclude additional, unrecited elements or method acts.

As used herein, the term “may” with respect to a material, structure, feature, or method act indicates that such is contemplated for use in implementation of an embodiment of the disclosure and such term is used in preference to the more restrictive term “is” so as to avoid any implication that other, compatible materials, structures, features and methods usable in combination therewith should or must be included or excluded.

As used herein, the singular forms “a,” “an,” and “the” include the plural forms as well, unless the context clearly indicates otherwise.

As used herein, the term “and/or” includes any and all combinations of one or more of the associated listed items.

As used herein, relational terms, such as “first,” “second,” etc., are used for clarity and convenience in understanding the disclosure and accompanying drawings and does not connote or depend on any specific preference, orientation, or order, except where the context clearly indicates otherwise.

As used herein, the term “about,” when used in reference to a numerical value for a particular parameter, is inclusive of the numerical value and a degree of variance from the numerical value that one of ordinary skill in the art would understand is within acceptable tolerances for the particular parameter. For example, “about,” in reference to a numerical value, may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

While embodiments of this disclosure have been described and illustrated herein with respect to specific ablation devices, those of ordinary skill in the art will recognize and appreciate that features and elements from different embodiments may be combined to arrive at further, additional airflow control devices and methods as contemplated by the inventors.

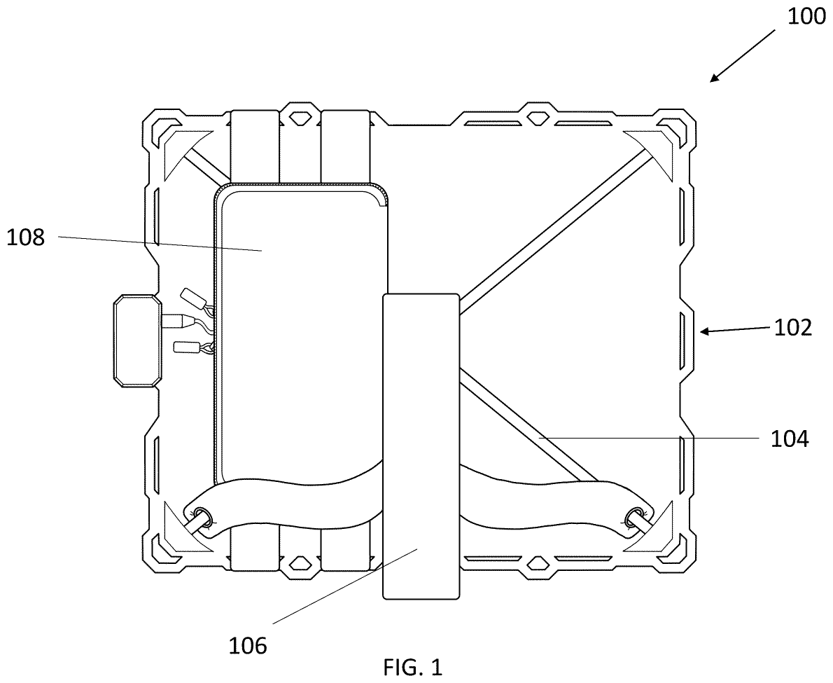

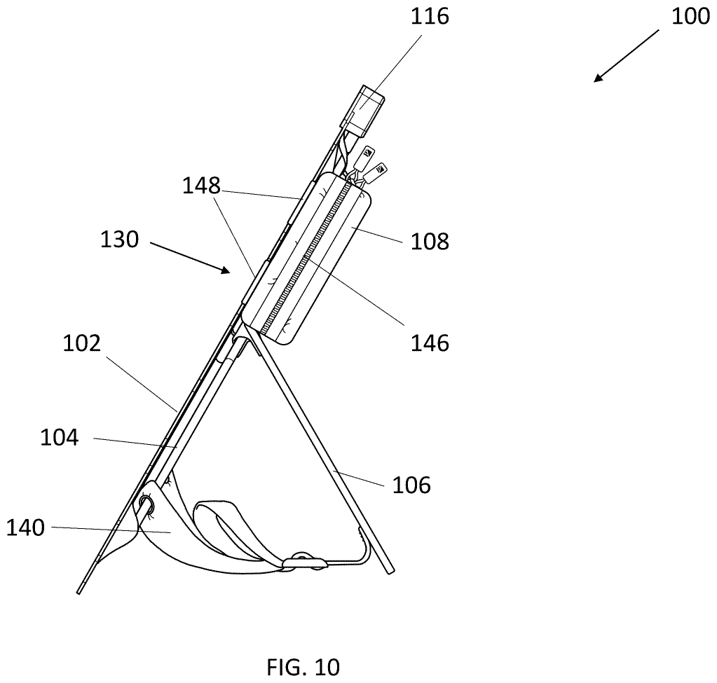

FIG. 1 shows a back side view of a portable solar panel assembly 100. The portable solar panel assembly may include a portable solar panel 102, a support structure 104, a kickstand 106, and a bag 108. The portable solar panel assembly 100 may be positionable in a deployed state and a stored state which will be discussed in greater detail below. In the deployed state, the support structure 104 is configured to removably attach to the portable solar panel 102 and is configured to support and orient the portable solar panel 102 toward a source of light. The kickstand 106 may be adjustable to control the angle at which the portable solar panels rests relative to vertical and horizontal planes, and to incident light rays. One example of such a deployed state is shown in FIG. 10. In the deployed state, the bag 108 is configured to removably attach to the portable solar panel 102 and may be sized, shaped, and configured to hold an electronic device.

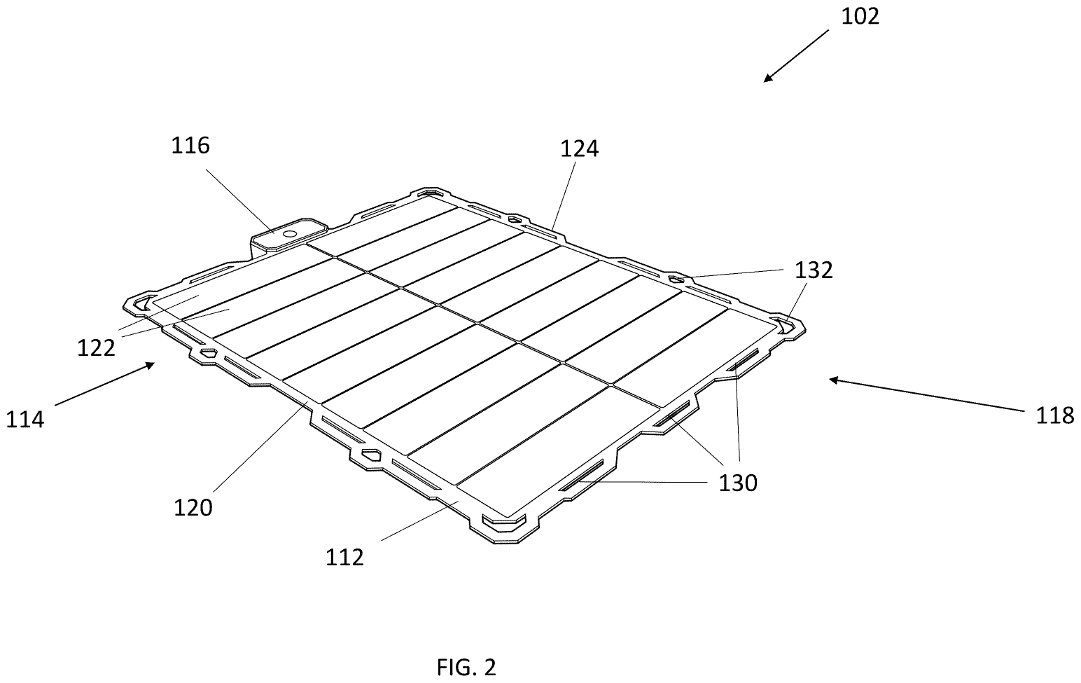

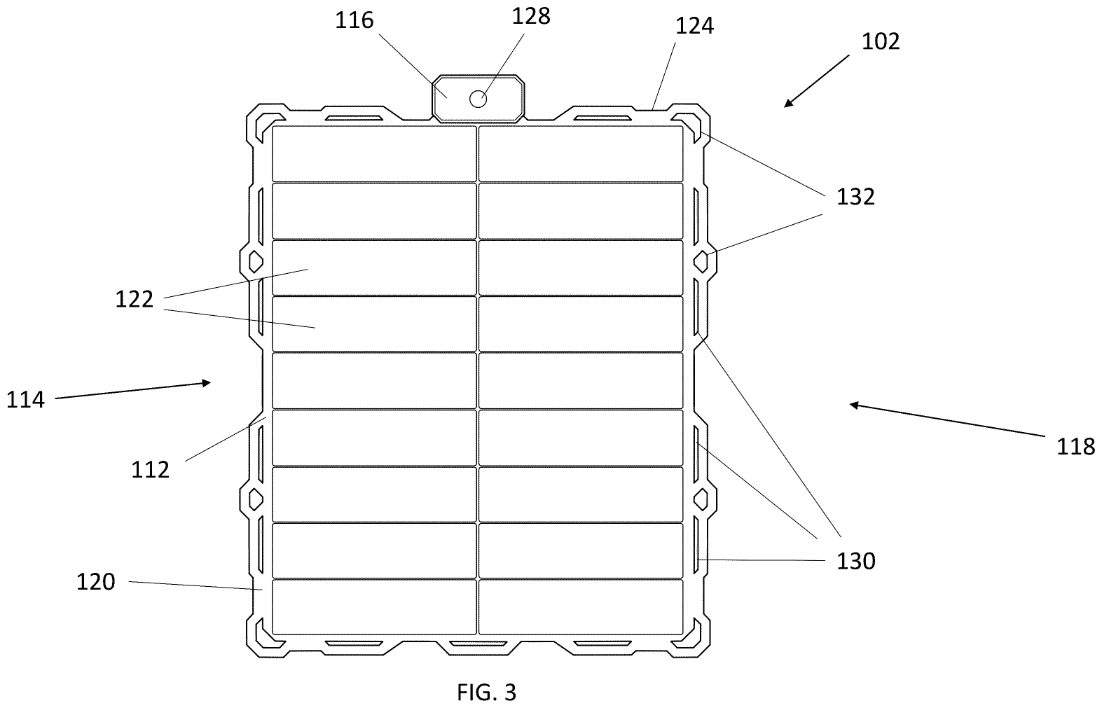

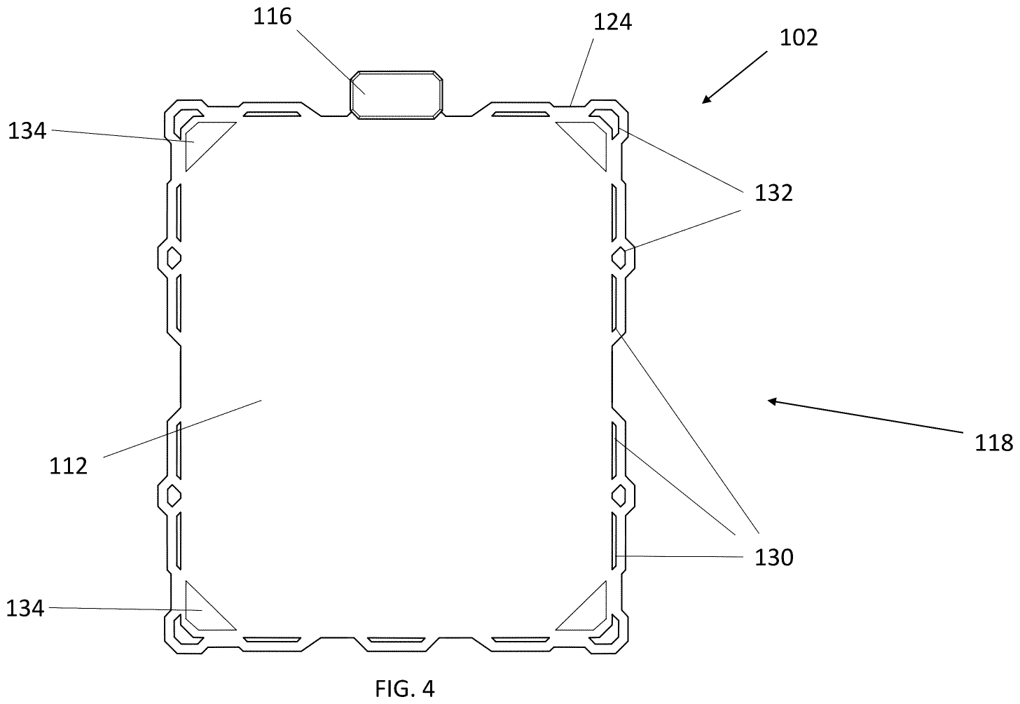

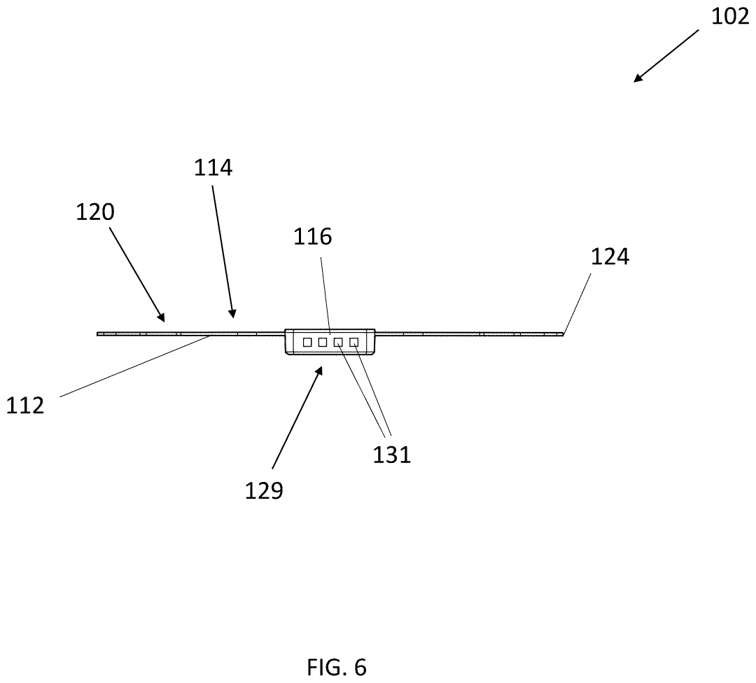

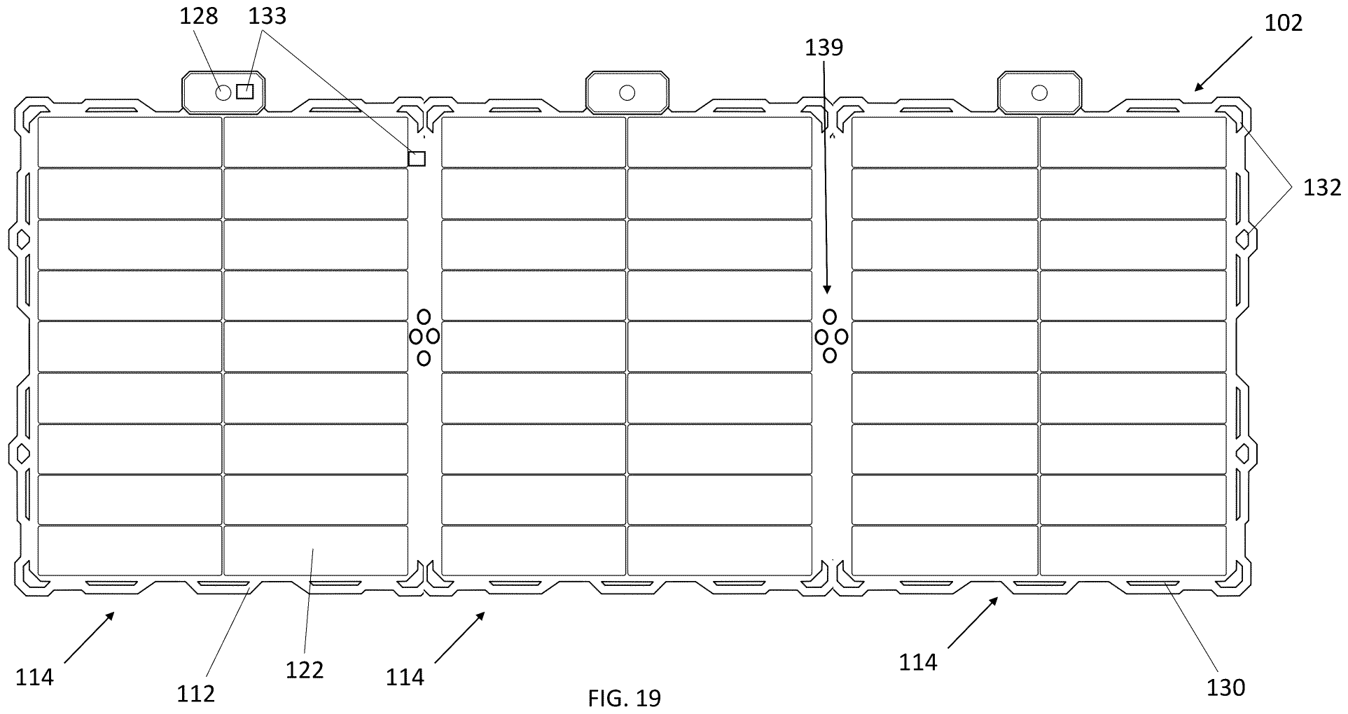

FIGS. 2-6 show various views of the portable solar panel 102 of FIG. 1. The portable solar panel 102 may include a flexible substrate 112, at least one array of solar cells 114, a port 116, and a set of connection features 118. The flexible substrate 112 may be configured to support the array of solar cells 114 on a first side 120 of the flexible substrate 112. In some embodiments, the flexible substrate 112 may support more than one array of solar cells 114, spaced apart on the first side 120 of the flexible substrate 112 (FIG. 19). The array of solar cells 114 may include CIGS (Copper Indium Gallium Diselenide) solar cells, such as those produced by MiaSolé Hi-Tech Corp out of Santa Clara, California. The array of solar cells 114 may include any number of individual cells 122. In some embodiments, the array of solar cells 114 may include eighteen individual cells 122. In some embodiments, the array of solar cells 114 may have less than eighteen individual cells 122 or more than eighteen individual cells 122. The size of the flexible substrate 112 may be determined by the number of individual cells 122. The number of individual cells 122 will determine the overall power output of the portable solar panel 102. Each individual cell 122 is capable of producing, on average, about one watt. In some embodiments, each individual cell 122 may be capable of producing, on average, more than one watt.

The flexible substrate 112 may include one or more layers of corrosion resistant and temperature resistant plastic, elastomeric polymers, electroactive polymers, thermoplastic polymers, and ripstop layers. The one or more layers of corrosion resistant and temperature resistant plastic may include a lightweight, high strength, fluorine-based plastic such as ETFE (Ethylene tetrafluoroethylene).

The one or more layers of elastomeric polymers may include any rubbery material composed of long chainlike molecules, or polymers, that are capable of recovering their original shape after being stretched to great extents, such as natural rubbers, styrene-butadiene block copolymers, polyisoprene, polybutadiene, ethylene propylene rubber, ethylene propylene diene rubber, silicone elastomers, fluoroelastomers, polyurethane elastomers, and nitrile rubbers. In some embodiments, the one or more layers of elastomeric polymers may include EVA (ethylene-vinyl acetate).

The one or more layers of electroactive polymers may include any material that exhibits a change in size, shape, or volume when stimulated by an electric field such as dielectric elastomers, ferroelectric polymers, electro-strictive graft polymers, or ionic polymers. The electroactive polymer may include a thin elastomeric film (e.g., silicone or acrylic), which is coated on both sides with or sandwiched between two electrodes. When an electrical voltage is applied between the electrodes, the opposite charges move from one electrode to the other and as a result squeeze the film in its thickness direction. Since the thin elastomeric film is close to incompressible this leads to an expansion of the electroactive polymer. When the voltage is turned off electroactive polymer returns to its original shape. In some embodiments, the one or more layers of electroactive polymers may replace at least one of the one or more layers of elastomeric polymers.

The one or more thermoplastic layers may include any material that can be softened through heating or applying a voltage across the one or more thermoplastic layers. As the temperature of the one or more thermoplastic layers increases, the thermoplastic layer may become pliable or malleable and may return to a rigid structure upon cooling. In some embodiments, the thermoplastic layer may be an electro-shapable material. The electro-shapable material may become soft upon application of a voltage across the material and may become rigid when the voltage is removed. In some embodiments, the electro-shapable material may become rigid upon application of a voltage across the material and may become soft when the voltage is removed.

The one or more ripstop layers may include woven fabrics configured using one or more reinforcing techniques configured to render them more resistant to tearing and ripping. In some embodiments, the one or more ripstop layers may include nylon. Forming the flexible substrate 112 may include selecting one or more layers of corrosion resistant and temperature resistant plastic, elastomeric polymers, electroactive polymers, thermoplastic polymers, and ripstop layers and heat pressing them together. In some embodiments, one or more layers of phosphorescent material and one or more layers of retro-reflective material may be selected and integrated into the flexible substrate 112. The phosphorescent material is configured to emit at least some level of light after being exposed to radiation such as solar radiation. The retro-reflective material is configured to reflect radiation such as light back to its source with minimal scattering.

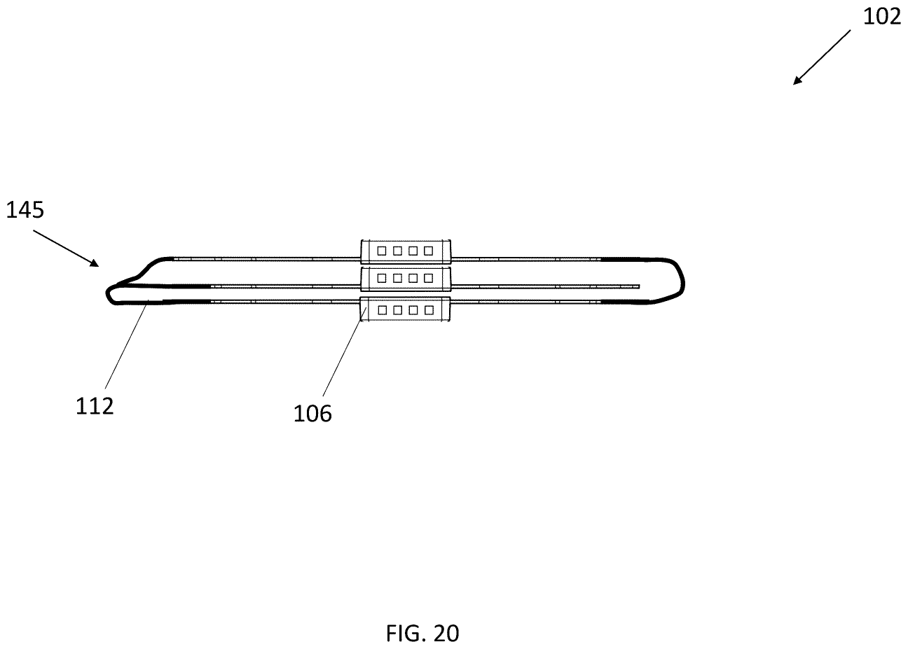

The flexible substrate 112 may be within a range of about 1-10 mm thick in a direction at least substantially perpendicular to a major surface of the flexible substrate 112. In some embodiments, the flexible substrate 112 may be about 5 mm thick in the same direction at least substantially perpendicular to a major surface of the flexible substrate 112. The array of solar cells 114 may be arranged in a grid like structure on the first side 120 of the flexible substrate 112. Each individual cell 122 in the grid like structure may be spaced substantially equally from adjacent cells 122. In some embodiments, there may be enough space between each individual cell 122 and/or between a select few individual cells 122 such that the array of solar cells 114 may be configured to allow space for additional connection features of the set of connection features 118 described below or other additional features to be integrated into the flexible substrate 112. In some embodiments, there may be at least two arrays of solar cells 114 arranged on the flexible substrate (FIG. 19-20). The at least two arrays of solar cells 114 may be the same size or may be different sizes, i.e., the number of cells 122 in each array of solar cells 114 may be identical or one array of solar cells 114 may have more cells 122 than the other array of solar cells 114. Each array of solar cells 114 may be separated by one or more connection features of the set of connection features 118.

The array of solar cells 114 may exhibit an at least substantially rectangular shape. In some embodiments, the flexible substrate 112 and the array of solar cells 114 may substantially exhibit a cross section having any shape. For example, in the plane of the major surface of the flexible substrate 112 on which the array of solar cells 114 is supportable, the flexible substrate 112 and the array of solar cells 114 disposed on the first side 120 may substantially exhibit any one or a combination of shapes, such as circular, triangular, oval, polygonal, rectangular, etc. In general, substantially rectangular shaped individual solar cells facilitate easier manufacturing and efficient use of space in a solar panel or an array.

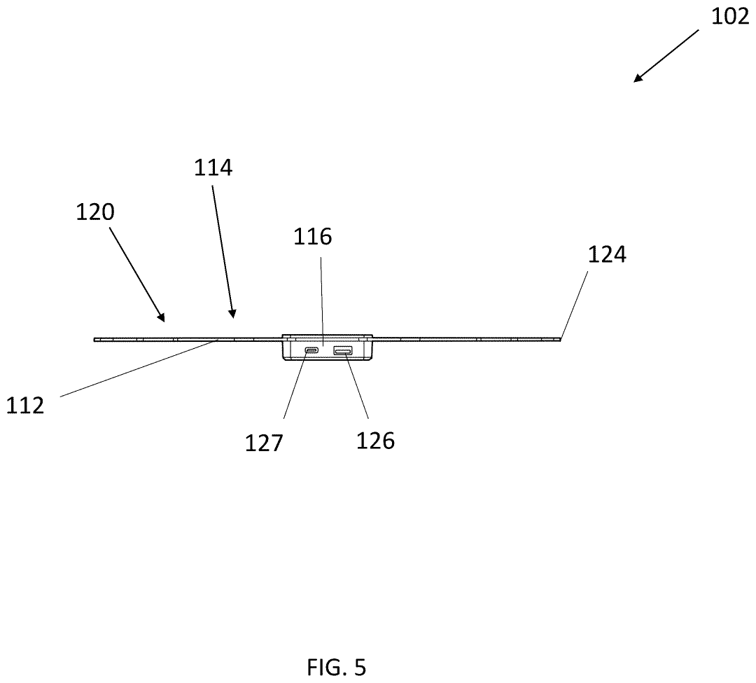

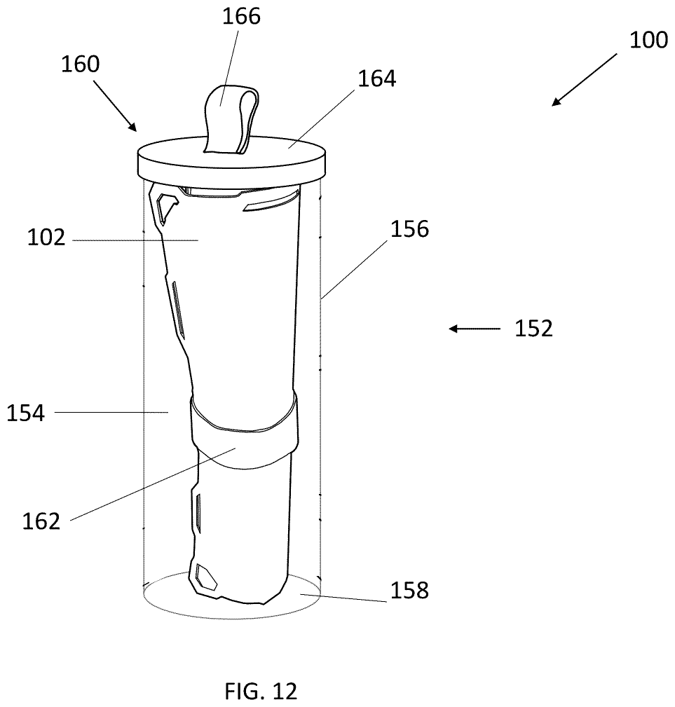

The array of solar cells 114 may be electrically connected to the port 116. The port 116 may be disposed anywhere on the flexible substrate 112. In some embodiments, the port 116 is disposed on an outer periphery 124 of the flexible substrate 112. The port 116 being on a periphery of the flexible substrate 112 facilitates storage of the portable solar panel 102 as will be discussed in further detail below relating to FIG. 12. The port 116 may be configured to facilitate the transfer of power collected from the array of solar cells 114 to an electronic device. The port 116 may have a USB receiver 126 and/or a USB-C receiver 127 as shown in FIG. 5. The USB receiver 126 and the USB-C receiver 127 may be used to transfer power from the portable solar panel 102 to an electronic device. The port 116 may also include a light sensor 128. The light sensor 128 may be positioned in the port 116 such that it may face at least substantially the same direction as the array of solar cells 114. The light sensor 128 may be operatively connected to an indicator system 129. The indicator system 129 may include one or more lights 131. The indicator system 129 may receive a signal from the light sensor 128 and activate one or more of the one or more lights 131. The number of the one or more lights 131 that may be activated may depend upon the level of light received by the light sensor 128. In some embodiments, the indicator system 129 may include 4 lights 131. In a cloudy or low light environment, the indicator system 129 may illuminate only one or zero of the one or more lights 131. In a very bright or sunny environment the indicator system 129 may illuminate all or most of the one or more lights 131. In some embodiments, the light sensor 128 may be disposed on or within the flexible substrate 112. The placement of the light sensor 128 within the flexible substrate 112 may facilitate a smaller overall shape for the port 116, facilitating easier storage of the portable solar panel 102. The USB receiver 126, the USB-C receiver 127, and the one or more lights 131, may also be disposed on or within the flexible substrate 112 with may further reduce the size of or remove the port 116 altogether, facilitating easier storage of the portable solar panel 102.

In some embodiments, the portable solar panel 102 may include one or more additional sensors 133. The one or more additional sensors 133 may be disposed on the port 106 or may be disposed on or within the flexible substrate 112. The one or more additional sensors 133 are configured to monitor at least one parameter of at least a portion of the array of solar cells 114. For example, the one or more additional sensors 133 may be at least one of a voltage sensor, a current sensor, a light sensor, a temperature sensor, a gyroscope, an accelerometer, a barometer, a humidity sensor, or an infrared sensor. There may be one additional sensor 133 for the portable solar panel 102, one for each array of solar cells 114, or one for each individual cell 122 of the portable solar panel 102. The additional sensors 133 are configured to collect information about the portable solar panel 102 and may be configured to selectively turn off or disconnect the portable solar panel 102, the one or more arrays of solar cells 114, or the individual cells 122. Selective powering off or disconnecting may be triggered by a short circuit, damage to at least a portion of the portable solar panel 102, or other programmed parameters depending on the type of data collected by the additional sensor 133.

Referring to FIGS. 1-4, the set of connection features 118 may be disposed on the outer periphery 124 of the flexible substrate 112 and may include a first set of connection features 130 and a second set of connection features 132. The first set of connection features 130 and the second set of connection features 132 may be formed in the flexible substrate 112. The forming of the first set of connection features 130 and the second set of connection features 132 may include a form of subtractive manufacturing, such as cutting, laser cutting, or stamping. The first set of connection features 130 may be configured to be compatible with the MOLLE (Modular Lightweight Load-carrying Equipment) system used by militaries from multiple countries. The term “MOLLE” is used technically to describe the specific system manufactured by Specialty Defense Systems, but is also casually used interchangeably to describe generically all load-bearing systems and subsystems that utilize the woven PALS (Pouch Attachment Ladder System) webbing for modular pouch attachment. The PALS grid may include, for example, horizontal rows of about 25 mm (about 1-inch) webbing, spaced about 25 mm apart, and attached to the backing at about 40 mm (about 1.5-inch) intervals. Stitching may be in the range of about 35-40 mm (about 1.4-1.6 inches) and is considered acceptable in practice. Further discussion of MOLLE can be found in the article by Tim Cooper, “Molle: The Evolution of the Modern Tactical Load Carrying System,” Free Range American, Free Range American, 28 Sep. 2020, https://freerangeamerican.us/history-of-molle/ which is incorporated by reference herein.

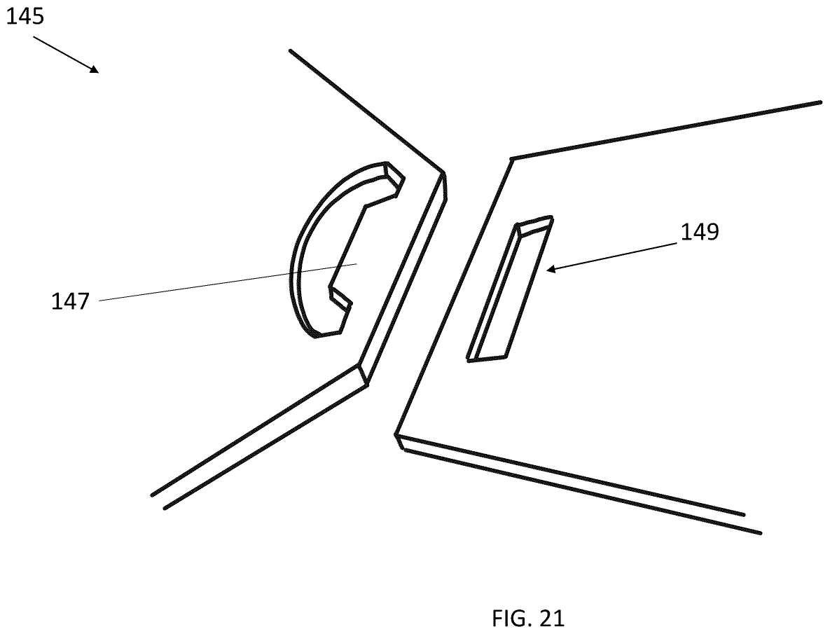

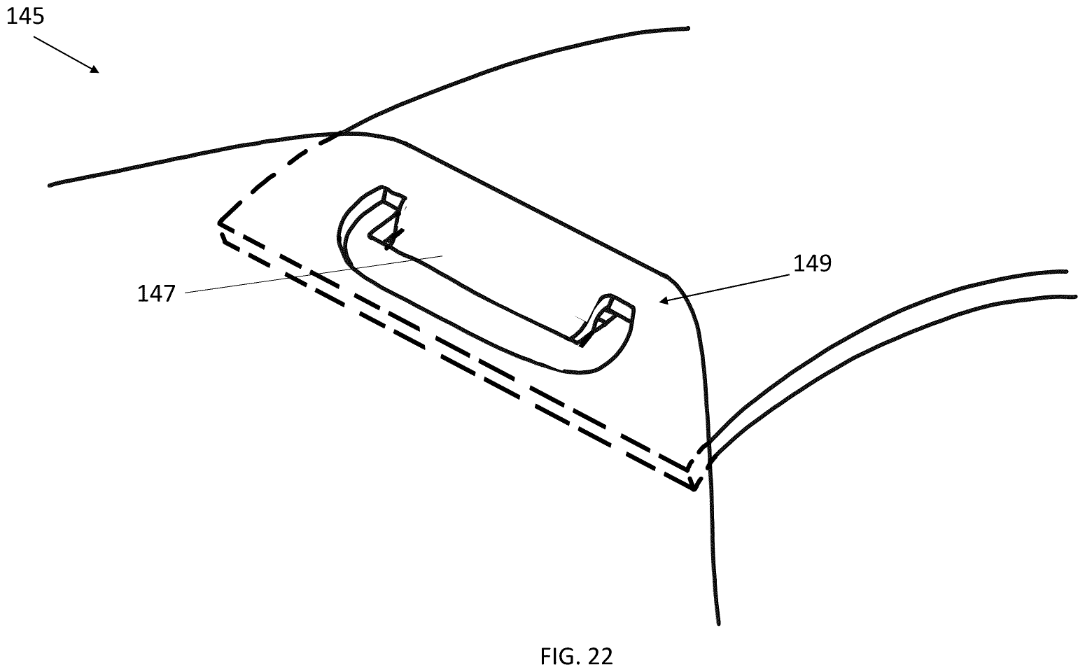

The second set of connection features 132 may be configured to receive other types of connection devices such as Velcro, magnets, carabiners, zip ties, snaps, buttons, buckles, straps, loops etc. and may substantially exhibit any one or a combination of shapes, such as circular, triangular, oval, polygonal, rectangular, etc. The second set of connection features 132 may be spaced evenly along the outer periphery 124. In some embodiments the second set of connection features 132 may not be spaced evenly along the outer periphery 124. In some embodiments, the second set of connection features 132 may include holes laser cut anywhere into the flexible substrate 112, e.g., around the outer periphery 124 or between some of the individual cells 122. The second set of connection features 132 may include one or more compliant mechanisms 145 (shown in detail in FIGS. 21-22) such as lamina emergent mechanisms (LEMs). As used herein, “compliant mechanism” is meant to be understood to refer to a flexible mechanism that achieves force and motion transmission through elastic deformation. The one or more compliant mechanisms 145 may be manufactured into the flexible substrate 112. The compliant mechanisms 145 may be configured to temporarily attach items to the portable solar panel 102 when it is in a deployed state or a stored state. One or more of the compliant mechanisms 145 may also be configured to secure the portable solar panel 102 in a deployed state or in a stored state, preventing the transition from the deployed state or the stored state without disengaging the one or more compliant mechanisms 145.

Referring to FIGS. 20-22, one or more of the compliant mechanisms 145 are configured to secure the portable solar panel 102 in a stored state. The compliant mechanism 145 includes a tab 147 and a slot 149. The tab 147 is configured to fit into the slot 149. The tab 147 may be any shape that facilitates temporary engagement with the slot 149. FIG. 21 shows the compliant mechanism 145 in a disengaged state which may correspond to the deployed state shown in FIG. 19. FIG. 22 shows the compliant mechanism 145 in an engaged state which may correspond to the stored state shown in FIG. 20. In the engaged state, the tab 147 is inserted into the slot 149 preventing relative motion of a portion of the portable solar panel 102 relative to another portion of the portable solar panel 102.

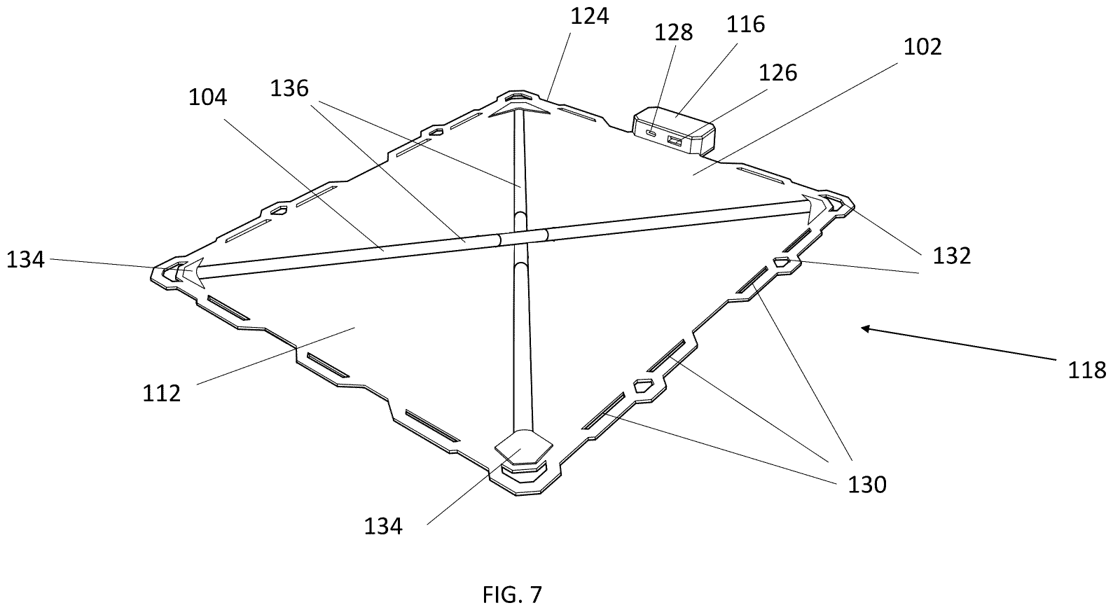

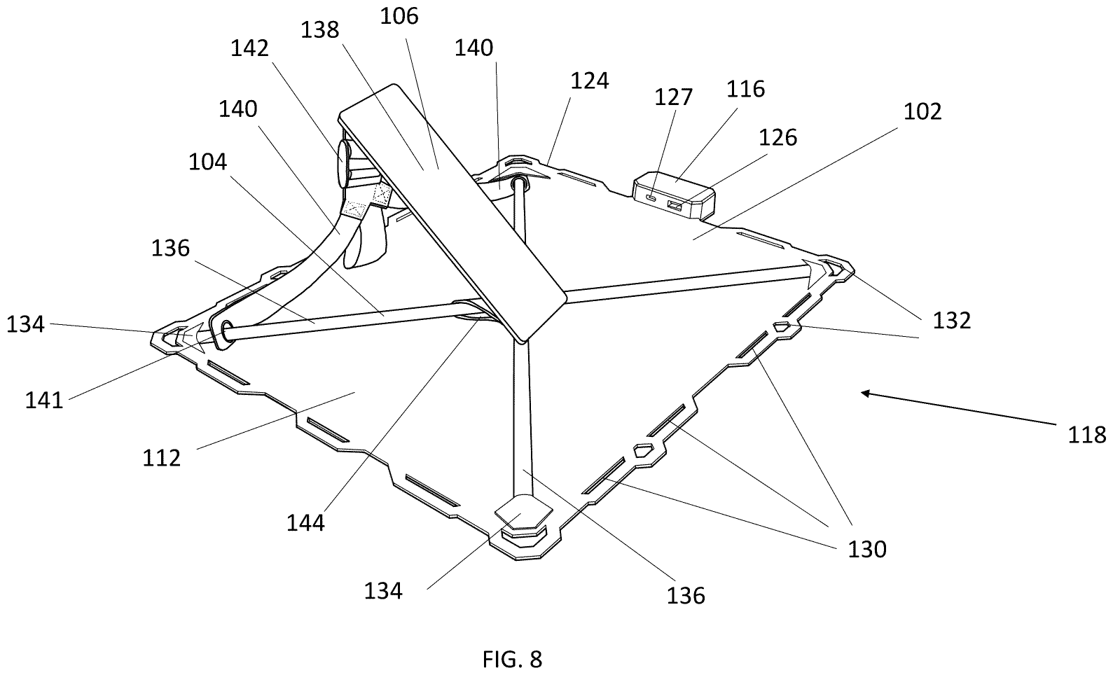

Referring to FIGS. 7 and 8, the flexible substrate 112 may include a third set of connection features 134. The third set of connection features 134 may include one or more pockets, clasps, grommets, elastic ribbons, loops, etc., and may be configured to at least partially receive the support structure 104 when the portable solar panel assembly 100 is in a deployed state. The third set of connection features 134 may be disposed at least substantially at the corners of the flexible substrate 112.

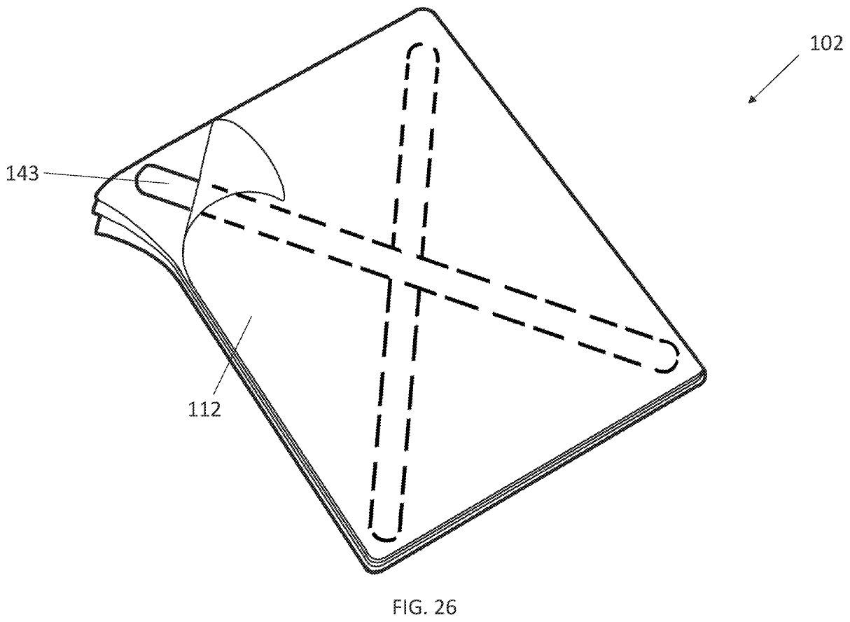

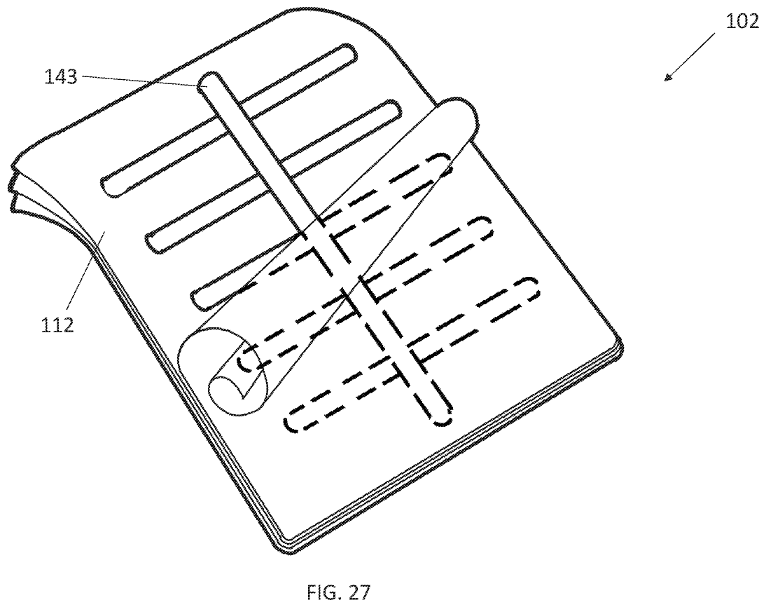

Referring to FIGS. 7 and 23-27, the support structure 104 is configured to facilitate temporary rigidity in the portable solar panel 102. As shown in FIG. 7, the support structure 104 may be configured to include a pair of shock-cord poles 136 having at least two sections each. As used herein, “shock-cord poles,” is meant to be understood as type of pole that folds into sections that are held together by an elastic cord. In some embodiments, sections of poles may be used that are threaded, clipped, telescoping, magnetic, accordion-style or use another method of temporary attachment or extension facilitating added stiffness to the portable solar panel 102 when the portable solar panel assembly 100 is in a deployed state. The support structure 104 may also include any combination of shock-cord, threaded, clipped, telescoping, magnetic, accordion-style or other methods of temporary attachment when in a deployed state. Temporary attachments and/or extensions facilitate efficient use of storage space when the portable solar panel assembly 100 is in a stored state. In some embodiments, the support structure 104 may be configured to have poles that follow the perimeter of the portable solar panel 102.

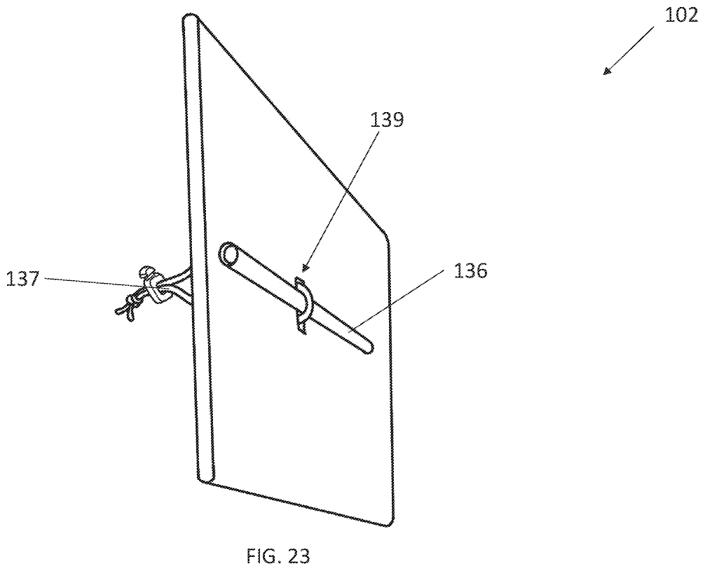

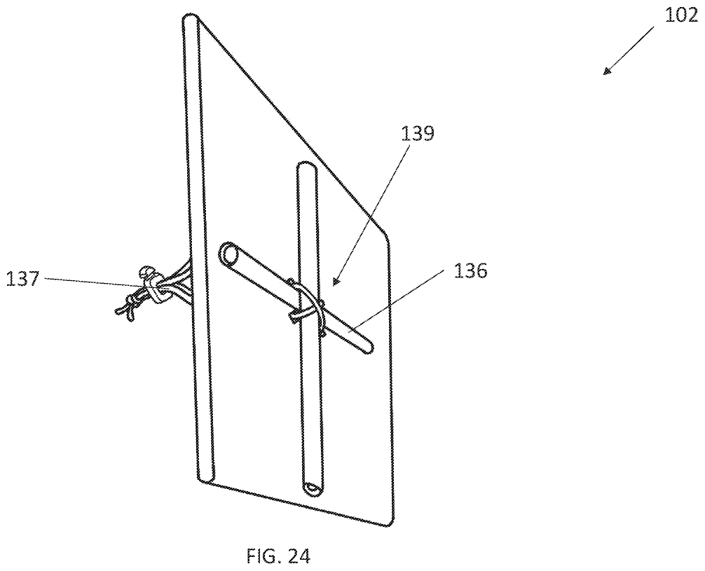

Referring to FIGS. 23-24, the support structure 104 may include one or more shock-cord poles 136 secured to the portable solar panel 102 by one or more straps 137. The one or more straps 137 are configured to pass through a set of openings 139 in the flexible substrate 112. The set of openings 139 may include two or more openings on opposing sides of each of the one or more shock-cord poles 136. The straps 137 are configured to secure the shock-cord poles 136 against the flexible substrate 112, thereby facilitating temporary rigidity of the portable solar panel 102. In some embodiments, there may be more than two shock-cord poles 136. The shock-cord poles 136 and the set of openings 139 may be disposed anywhere on the flexible substrate 112.

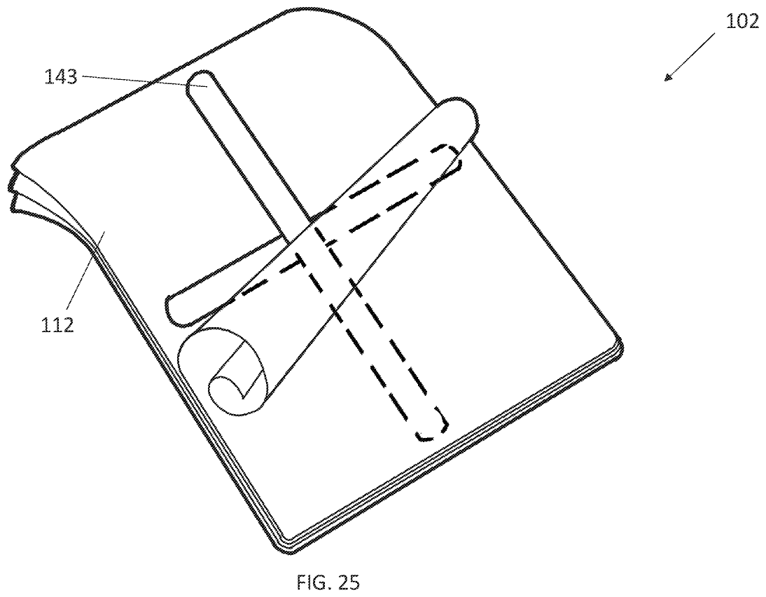

Referring to FIGS. 25-27, the portable solar panel 102 may include an internal skeleton 143. The internal skeleton 143 may include removable, rigid members or may comprise an electroactive polymer that can transition between a rigid state and a flexible state. The internal skeleton 143 may be disposed between any one of the one or more layers of corrosion resistant and temperature resistant plastic, elastomeric polymers, electroactive polymers, thermoplastic polymers, and ripstop layers of the flexible substrate. In some embodiments, the internal skeleton 143 is disposed withing the one or more layers of electroactive polymers. The internal skeleton 143 is configured to facilitate temporary rigidity of the portable solar panel 102. The shape of the internal skeleton 143 when observed in the major plane of the flexible substrate 112 may exhibit an “X” shaped pattern, a ladder pattern, a grid-like pattern, or other shape that may provide substantial rigidity for the portable solar panel 102.

Referring to FIGS. 8, 10, and 11, the kickstand 106 is configured to prop the portable solar panel 102 up, and orient the portable solar panel 102 at a selectable angle relative to a horizontal plane and to rays of incident light, as depicted in FIG. 10. The kickstand 106 may include a rigid member 138, a pair of flexible straps 140, a clip 142, and a loop 144. The rigid member 138 may be configured to support the weight of the portable solar panel assembly 100 when in the deployed state. The pair of flexible straps 140 may be configured to be coupled to the rigid member 138 by the clip 142 and the pair of flexible straps 140 may be configured to removably attach to the support structure 104, the second set of connection features 132, or the set of openings 139. The flexible straps 140 may include an opening 141 configured to at least partially receive the support structure 104. The opening 141 may also be configured to include additional hardware such as clips, grommets, hooks, etc. to facilitate the connection of the flexible straps 140 and the support structure 104, the second set of connection features 132, or the set of openings 139. In the deployed state, the flexible straps 140 may be taut between the clip 142 and the support structure 104. The flexible straps 140 may be configured to create a mechanical interference and restrict the angle at which the kickstand rests relative to the flexible substrate 112. The clip 142 may be configured to couple the rigid member 138 to the flexible straps 140. The flexible straps 140 may be adjustable relative to the clip 142 facilitating adjustment of the angle of the kickstand 106. Increasing the length of the flexible straps 140 between the support structure 104 and the clip 142 may result in a larger angle between the kickstand 106 and the flexible substrate 112. Decreasing the length of the flexible straps 140 between the support structure 104 and the clip 142 may result in a smaller angle between the kickstand 106 and the flexible substrate 112. The angle between the kickstand 106 and the flexible substrate 112 may be within a range from about 0 degrees to about 180 degrees. The angle may be chosen such that the portable solar panel 102 may at least substantially face the sun such that sunlight contacts the array of solar cells 114 in a direction that is substantially normal to the first side 120.

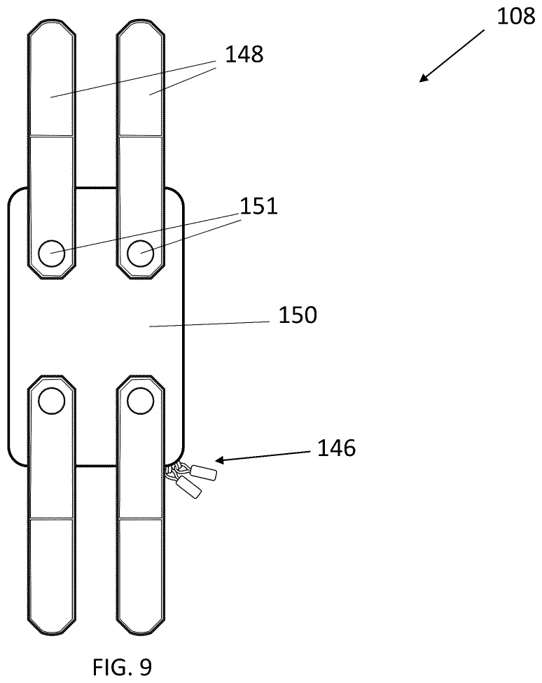

Referring to FIGS. 9-11, the bag 108 may be configured to hold the electronic device, any USB or USB-C cables that may be used with the portable solar panel assembly 100, and any other items a user may want to store. The bag 108 may be configured to be water-resistant (e.g., waterproof) and temperature resistant. The bag 108 may be configured to shield the electronic device receiving power from the portable solar panel 102 from direct sunlight or residual heat reflecting from surfaces in the surrounding environment that the portable solar panel assembly 100 is being deployed in. Shielding the electronic device from direct or indirect sunlight or heat facilitates protection of the electronic device. The bag 108 may include a zipper 146 configured to enclose the electronic device inside of the bag 108 while reducing exposure to the surrounding environment. The zipper 146 may be water-resistant (e.g., waterproof). The bag 108 may also include straps 148. In some embodiments, there may be four straps 148 attached to a first side 150 of the bag 108. In some embodiments there may be more than four straps 148 or less than four straps 148. The straps 148 may be configured to be MOLLE compatible and compatible with the first set of connection features 130. The straps 148 may be coupled to the bag 108 by fasteners 151. The fasteners 151 may be configured to facilitate rotation of the straps 148 360 degrees about the fasteners 151. For example, the straps 148 may be pinned to the bag 108 and may be rotatable about the pins. The range of motion in the straps 148 may facilitate temporarily fastening the bag 108 to any surface or structure that the straps 148 can reach, such as a tree, rock, tent, bush, vehicle, pack, or person. Each strap 148 may further include Velcro to facilitate temporary connection. In some embodiments, the straps 148 may include other structures that facilitate temporary attachment, such as magnets, suction cups, hooks, etc.

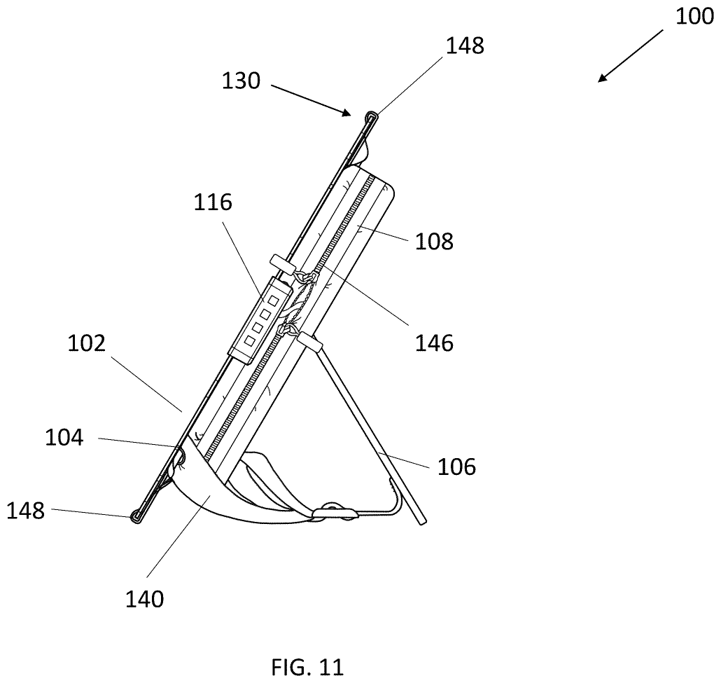

Referring to FIGS. 10-12, the portable solar panel assembly may be positionable in a deployed state and a stored state. Examples of deployed states are shown in FIGS. 10 and 11 and an example of a stored state is shown in FIG. 12. In the deployed state, the portable solar panel 102 may be removably coupled to one or more of the support structure 104, the kickstand 106, the bag 108, or another surface or structure, such as a tree, rock, tent, bush, vehicle, pack, or person. In the deployed state, the portable solar panel assembly 100 may be positioned and configured to collect sunlight and convert that sunlight into power for charging or powering an electronic device. The kickstand 106 is configured to be able to be removably attached in the deployed state relative whichever orientation may be more beneficial in the environment that the portable solar panel assembly 100 is being deployed.

Referring to FIG. 12, the portable solar panel assembly 100 may include a storage tube 152. The storage tube 152 may include a cavity 154 defined by an outer wall 156 and a first end 158. The storage tube 152 may have an open end 160 configured to facilitate receiving the portable solar panel 102, the support structure 104, the kickstand 106, and the bag 108 into the cavity 154. The storage tube 152 may be sized, shaped, and configured to hold the portable solar panel 102, the support structure 104, the kickstand 106, the bag 108, and optionally one or more other accessories when in the stored state. The portable solar panel 102 may be configured to roll into a substantially cylindrical form having a diameter smaller than the storage tube 152 to facilitate insertion into the storage tube 152. In some embodiments, there may be a storage strap 162 that may be configured to retain the shape of the portable solar panel after it is rolled up for storage. The support structure 104, the kickstand 106, and the bag 108 may be configured to fit inside the cavity created by the portable solar panel 102 when it is rolled up. The storage tube 152 may include a lid 164. The lid may be configured to fit over the open end 160 and contain the portable solar panel 102, the support structure 104, the kickstand 106, and the bag 108 within the cavity 154. The lid 164 may be threaded to match complimentary threads on the outer wall 156 (or the inner wall) of the storage tube 152, press fit, secured with clips, or another form of removable connection. The lid may also include a loop 166. The loop 166 may be configured to hang or secure the storage tube to a hook, branch, pack, etc. The outer wall 156 of the tube may include a substantially translucent or transparent material. The portable solar panel assembly 100 may be configured to act as a lamp. In some embodiments, the portable solar panel 102 may be configured to absorb sunlight into a phosphorescent material in the deployed state and emit light through the outer wall 156 when in the stored state.

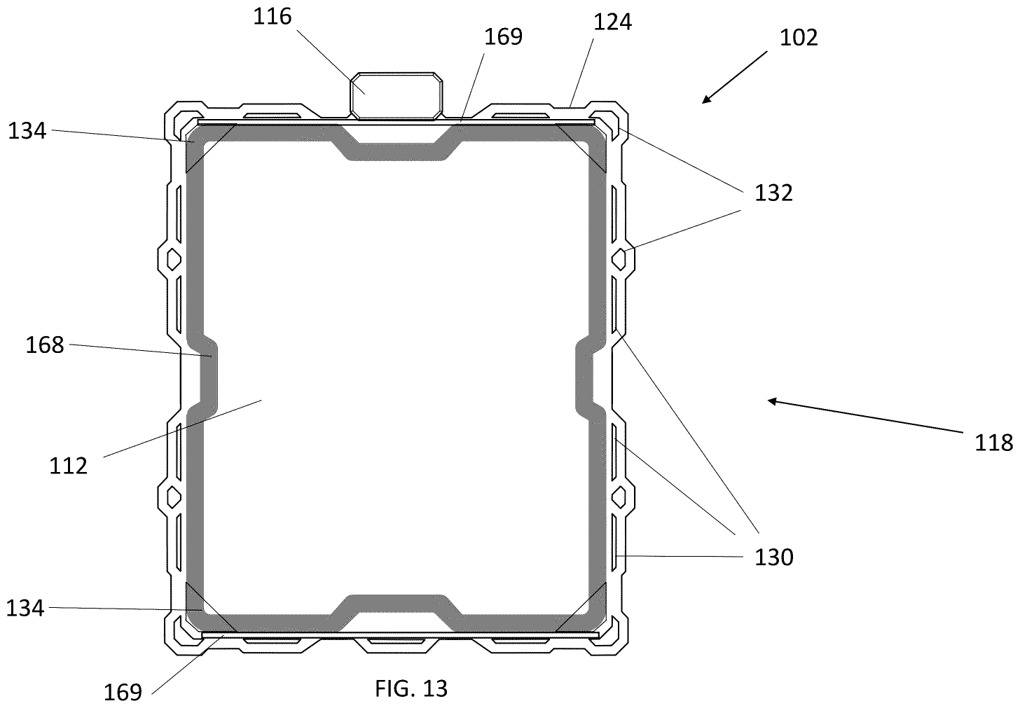

Referring to FIG. 13, the portable solar panel 102 may include an antenna 168. The antenna 168 may be configured to be integrated into the flexible substrate 112. The antenna 168 may be configured to amplify the signal for any signal-receiving devices that may be connected to the portable solar panel 102, such as a radio, cell phone, navigation system, etc. The antenna may be configured to be at least substantially the same shape as the outer periphery 124. In some embodiments the antenna 168 may take any shape in the flexible substrate 112. The portable solar panel 102 may include rigid shafts 169 disposed on opposite edges of the flexible substrate 112 and configured to increase the stiffness of the flexible substrate 112. The rigid shafts 169 may increase the stiffness on the flexible substrate 112 in one direction while allowing the flexible substrate 112 to bend in another, substantially perpendicular direction.

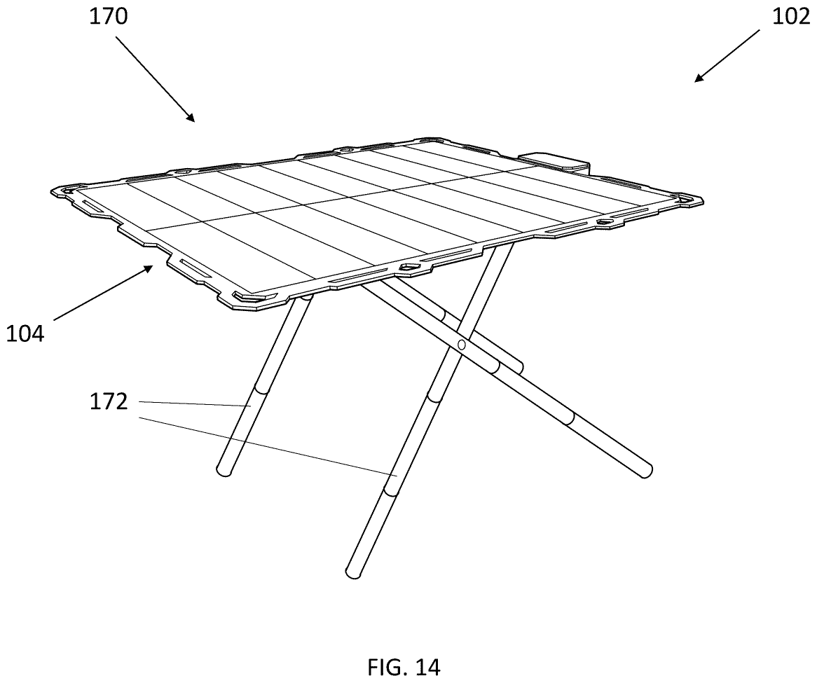

Referring to FIG. 14, the portable solar panel 102 may be deployed as a tabletop 170. When deployed as the tabletop 170, the portable solar panel 102 may be removably connected to the support structure 104 such that the tabletop 170 is a substantially rigid, flat, taut surface. In some embodiments, the tabletop 170 may be substantially parallel to a horizontal plane. The tabletop 170 may be operatively connected to legs 172. The legs 172 may include one or more sections 174 that may be threaded, clipped, telescoping, magnetic, accordion-style or any combination thereof.

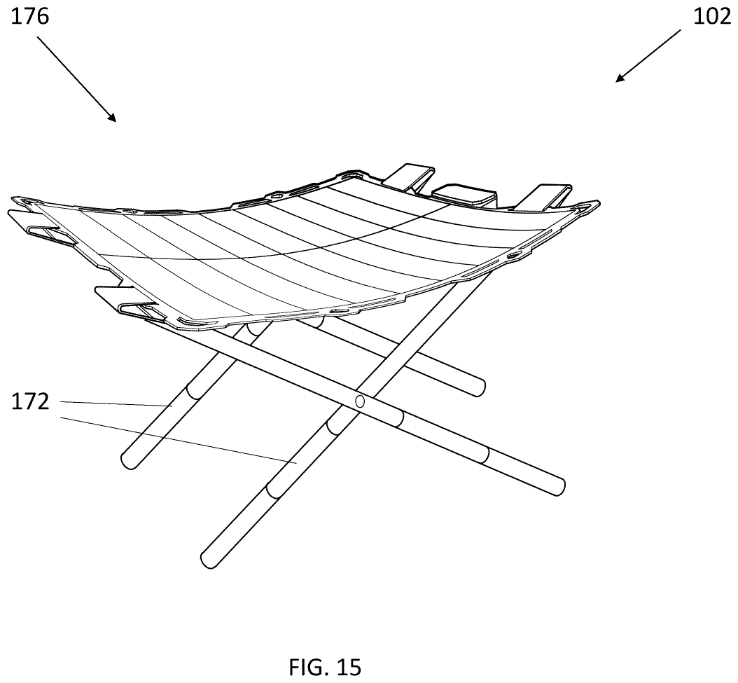

Referring to FIG. 15, the portable solar panel 102 may be deployed as a surface 176 that may be configured to sit on. When deployed as the surface 176, the portable solar panel may be connected to legs 172 and the portable solar panel 102 may be connected to the support structure such that the surface 176 is substantially not rigid, flat, or taut. In some embodiments the portable solar panel 102 may not be connected to the support structure 104.

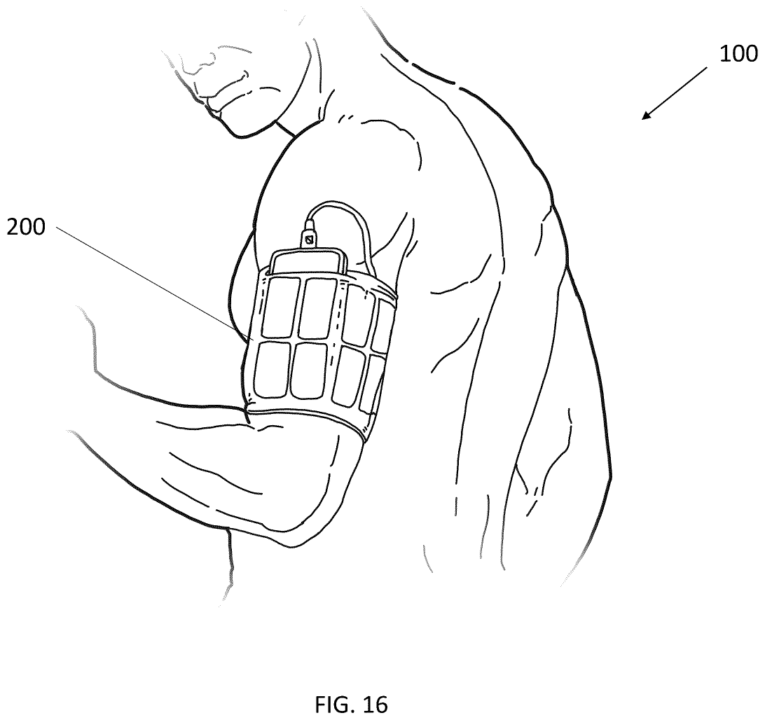

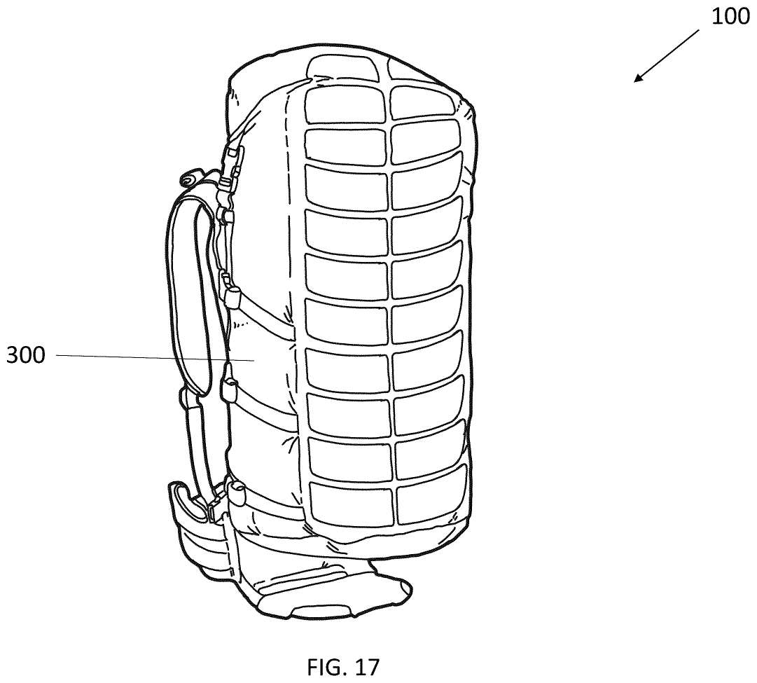

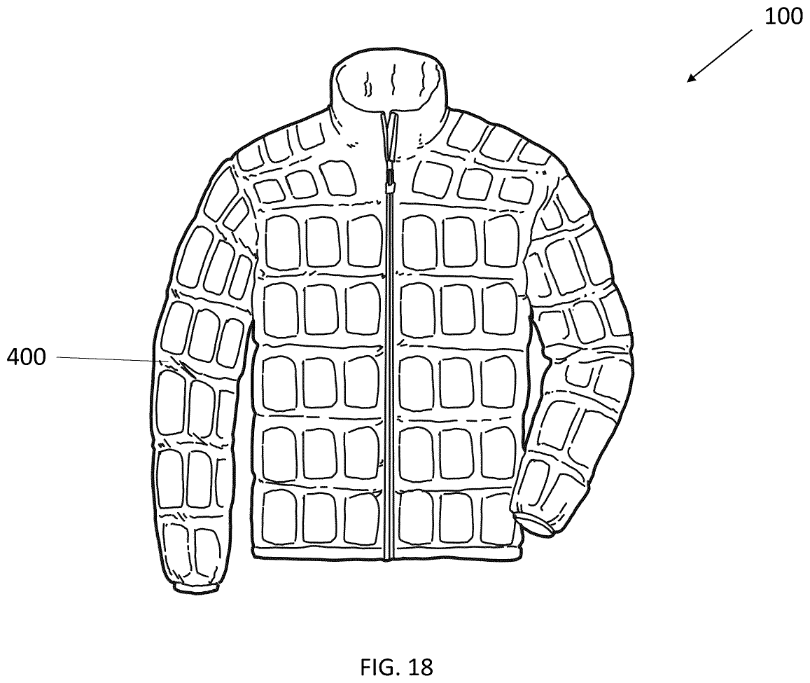

Referring to FIGS. 16-18, the portable solar panel assembly 100 may at least partially be integrated into an arm band 200, a pack 300, and a jacket 400.

The embodiments of the disclosure described above and illustrated in the accompanying drawing figures do not limit the scope of the disclosure, since these embodiments are merely examples of embodiments of the invention, which is defined by the appended claims and their legal equivalents. Any equivalent embodiments are intended to be within the scope of this disclosure. Indeed, various modifications of the present disclosure, in addition to those shown and described herein, such as alternative useful combinations of the elements described, will become apparent to those of ordinary skill in the art from the description. Such modifications and embodiments also fall within the scope of the appended claims and their legal equivalents.

What is claimed is:

1. A portable solar panel, comprising:
a flexible substrate;
an array of solar cells supported on the flexible substrate;
a port supported on the flexible substrate and configured to receive power collected by the array of solar cells and to enable connection to the array of solar cells for delivery of power via the port; and
a set of connection features disposed along a periphery of the flexible substrate, the set of connection features configured to be MOLLE compatible.

2. The portable solar panel of claim 1, wherein each solar cell of the array of solar cells is configured to function independently of each other cell of the array of solar cells.

3. The portable solar panel of claim 1, wherein the array of solar cells comprises copper indium gallium diselenide solar cells.

4. The portable solar panel of claim 1, wherein the port is configured to enable connection of the portable solar panel to multiple devices to enable simultaneous charging.

5. The portable solar panel of claim 1, further comprising two rigid shafts disposed on opposite edges of the flexible substrate configured to increase stiffness of the flexible substrate.

6. The portable solar panel of claim 1, further comprising additional connection features disposed between cells of the array of solar cells.

7. The portable solar panel of claim 1, further comprising an antenna operatively connected to the port and configured to boost signal reception when the portable solar panel is connected to a signal receiving device via the port.

8. A method for manufacturing a solar panel, comprising:
forming a flexible substrate having layers of corrosion resistant and temperature resistant plastic, elastic polymers, and ripstop material;
applying an array of solar cells to a first side of the flexible substrate;
attaching a port to the flexible substrate and connecting the port of the array of solar cells, the port configured to enable transfer of power collected by the array of solar cells to an electronic device; and
forming a set of connection features on the flexible substrate.

9. The method of claim 8, wherein forming the set of connection features comprises forming the set of connection features of the flexible substrate by subtractive manufacturing.

10. The method of claim 9, wherein forming the set of connection features comprises at least one of cutting, stamping, or laser cutting the set of connection features out of the flexible substrate.

11. The method of claim 8, wherein forming the flexible substrate further comprises forming the flexible substrate to comprise a phosphorescent layer and a retro-reflective layer.

12. A portable solar panel assembly, comprising:
a flexible solar panel having an array of solar cells;
a support structure configured to removably attach to the flexible solar panel when the portable solar panel assembly is in a deployed state;
a kickstand configured to removably attach to the support structure and configured to prop the flexible solar panel up when the portable solar panel assembly is in a deployed state; and
a bag configured to removably attach to the support structure and sized, shaped, and configured to hold an electronic device connectable to the flexible solar panel.

13. The portable solar panel assembly of claim 12, wherein the flexible solar panel includes a first set of connection features configured to be MOLLE compatible.

14. The portable solar panel assembly of claim 13, wherein the flexible solar panel includes a second set of connection features different from the first set of connection features.

15. The portable solar panel assembly of claim 13, wherein the flexible solar panel includes a third set of connection features different from the first set of connection features, the third set of connection features configured to attach to the support structure such that the flexible solar panel is taut when the portable solar panel assembly is in a deployed state.

16. The portable solar panel assembly of claim 14, wherein the second set of connection features comprises one or more pockets, clasps, grommets, elastic ribbons, or loops.

17. The portable solar panel assembly of claim 12, wherein the support structure includes one or more shock-corded poles, telescoping poles, or accordion-style poles.

18. The portable solar panel assembly of claim 12, wherein the bag includes one or more straps configured to rotate freely about a point where the straps are coupled to the bag.

19. The portable solar panel assembly of claim 12, wherein the flexible solar panel includes a light sensor and indicator system.

20. The portable solar panel assembly of claim 12, further comprising a storage tube sized, shaped, and configured to hold the flexible solar panel, the support structure, the kickstand, and the bag, wherein the storage tube is translucent.
